(19) United States
(12) Patent Application Publication
(10) Pub. No.: US 2007/0024466 A1
(43) Pub. Date: Feb. 1, 2007

(54) System for controlling information relating to a vehicle

(76) Inventor: Paul Grison, Cagnes sur Mer (FR)

Correspondence Address: JAMES C. LYDON, 100 DAINGERFIELD ROAD, SUITE 100, ALEXANDRIA, VA, 22314, US

(21) Appl. No.: 10/576,366

(22) PCT Filed: Oct. 21, 2004
(86) PCT No.: PCT/FR04/02697

§ 371 Date: Apr. 19, 2006

(30) Foreign Application Priority Data
Oct. 21, 2003 (FR) 0312309

(51) Int. Cl. G08G 1/00

(52) U.S. Cl. 340/904

(57) ABSTRACT

A system for controlling information relating to a vehicle (10), including information relating to criteria the vehicle must meet according the regulations in force, in which a chip card may be read by any authorised person (14) in order to control static and/or dynamic information relating to the vehicle using a data input device. The chip card is a contactless chip card (12) permanently arranged inside the vehicle and the data input device (16) includes a contactless card reader for remotely reading information stored in the card and a display screen on which input information is displayed.

### TECHNICAL FIELD

The present invention concerns the controlling of vehicle compliance by the public authorities, and in particular a system for controlling information relating to a vehicle.

### STATE OF THE ART

Vehicles, whether they are motor vehicles, lorries or buses are subject to constraints which are increasing over time. Therefore, all motor vehicles must demonstrate they are covered by an insurance liability. Each vehicle is thus obliged to display, in the corner of the front window and inside the vehicle, an insurance certificate (currently green) which contains the information relating to the identification of the insured vehicle and the expiry date of the insurance. Any control official, such as a police officer, can therefore be satisfied that the vehicle displaying the certificate is indeed insured.

The above system has, however, a number of disadvantages. Firstly, there is the possibility of error insofar as there is human intervention in the input of information. This input can be time-consuming and tedious. Furthermore the certificate on the windscreen has to be small in size and the information on it is thus limited (currently the contract number, the registration number, the validity date and the name of the insurance). The certificate is thus easy to falsify using commercially available copying materials. Finally, the insurance certificate does not include information on the make of the vehicle and it is thus easy to place a genuine certificate on another vehicle, which is of a different make, by fitting a matching number plate.

The problems mentioned above have been partially solved in the system described in document U.S. Pat. No. 5,459,304 in which a chip card belonging to a vehicle owner contains all of the information relating to the identification of the vehicle, the vehicle driving authorisations, the vehicle insurances, the offences involving the vehicle etc. The card can be connected to a plurality of databases containing the updates of this information. Unfortunately, this card is kept by the owner of the vehicle and must be inserted in a suitable reader in order to be read, which means that it cannot be controlled in the absence of the vehicle owner.

As regards the particular case of lorries, there is another problem to be added to those above, that is the drivers are actually subject to a constraint. Each lorry is currently equipped with a device, which enters on a paper chart, information concerning the distance in kilometres travelled that day, the number of driving hours and the compulsory break times. This chart, which is associated with the driver, can be controlled by a police officer in order to ascertain that the regulations imposed on lorry drivers have definitely been observed. However, as in the case of the insurance certificate, the lorry chart has a number of disadvantages. Firstly, it is not always easy to position. It is complex to read and to interpret, as is admitted by the police officers responsible for the control. Furthermore, each chart is specific to the driver who uses one chart per day and per vehicle. If he changes vehicle during the course of the day, he uses a new chart for the new vehicle. This system thus requires that the charts are kept and administered by the drivers, and there are therefore risks inherent in any human handling.

### DISCLOSURE OF THE INVENTION

It is therefore the aim of the invention to provide a system for controlling information relating to a vehicle which does not require information to be input manually by the control official.

Another aim of the invention is to provide a system for controlling information relating to a vehicle in which the information to be controlled is difficult to falsify.

Another aim of the invention is to provide a system for controlling information relating to a vehicle in which the control is carried out automatically by an authorised person without requiring the presence of the vehicle owner.

The object of the invention is therefore a system for controlling information relating to a vehicle in which a chip card, containing the information relating to the criteria which the vehicle must satisfy according to the regulations in force, such that the card can be inspected by any authorised person in order to carry out the control of static and/or dynamic information relating to the vehicle using a data input device. The chip card is a contactless chip card placed permanently inside the vehicle and the data input device includes a contactless card reader adapted to remotely read the information recorded in the card and a display screen onto which the information is displayed.

According to a particular application of the invention, the contactless chip card further contains dynamic information relating to the distance covered by the vehicle over a set period of time, for example, a day, as is the case with heavy goods vehicles.

### BRIEF DESCRIPTION OF THE FIGURES

The aims, objects and characteristics of the invention shall become more apparent from the following description with reference to the drawings, in which:

FIG. 1 shows a block-diagram of the system for controlling information according to the invention,

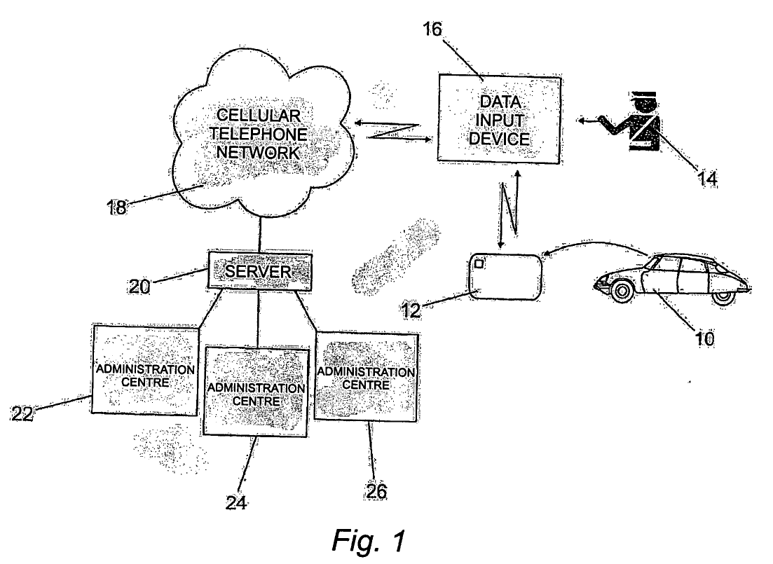

FIG. 2 shows a time-dependant diagram of the messages transmitted between the card and the data input device, and

FIG. 3 shows a time-dependent diagram of the messages transmitted between the data input device and an administration centre.

### DETAILED DESCRIPTION OF THE INVENTION

According to the invention, each vehicle 10 has a contactiess chip card 12 permanently placed inside the vehicle so as to be readable by an adapted reader. This card can, for example, be in a case fixed in the lower right-hand corner of the front window as is currently the case with insurance certificates.

This chip card contains, in the chip memory, static information relating to the vehicle, i.e. information relating to the criteria which must be satisfied by the vehicle according to the regulations in force, and can contain dynamic information, for example, information regarding the distance covered by the vehicle in the course of the day such as that currently entered on the lorry charts as will be seen hereafter.

The static information contained in the chip card can be of any type, but mainly consists of the following information:
type of vehicle
make of vehicle
registration number
identification number
insurance name
insurance contract number
validity date of said contract

It is to be noted that an additional, different and inaccessible, identification number is integrated into recent vehicles in the lower part of the windscreen. In case of control, this identification number is readable through a reading window made in the windscreen.

Any control official, such as a police officer 14 who wishes to carry out a control on a vehicle is provided with a data input device 16 which is in the form of a box of small dimension, for example 15 cm long, 10 cm wide and 2 cm deep, and has a GSM (or GPRS or UMTS) unit for accessing a cellular telephone network 18. It also comprises a display screen and can comprise an alphanumeric keyboard.

The data input device comprises a contactless chip card reader which allows the police officer to remotely input the card information without the need for the vehicle owner to be present. The police officer places his data input device relatively close to the card. According to a well known art, the contactless chip card has an antenna connected in parallel to the chip in order to receive the electromagnetic signals emitted by the reader located in the data input device, generally at a frequency of 13.56 MHz. These electromagnetic signals received by the antenna provide the chip with the power necessary for it to transmit the desired information to the reader by means of retromodulation of the electromagnetic signals, for example, at a frequency of 847 KHz.

The information from the chip is displayed on the display screen of the data input device 16, which allows the police officer 14 to carry out controlling. He can therefore check the validity of the insurance, check the vehicle registration number, compare the vehicle identification number displayed with that which is located in the window of the windscreen in order to ascertain that they are in fact identical, etc.

Supposing that the police officer 14 is suspicious about a vehicle (has it been stolen?) or the information supplied by the card. In this case, and according to a specific embodiment, the data input device 16 has, as mentioned above, a unit for connection to the cellular telephone network 18 like a mobile phone. The police officer can then connect, via a server 20, to one of the administration centres 22, 24, 26 which keep the centralised information which should be on the card. There could be an insurance administration centre, a vehicle testing administration centre and a driving licence penalty point administration centre. With regards to vehicle registration certificates, the authorities which keep this type of information can also each act as an administration centre. Within a very short time, the information provided by the card is transmitted to the appropriate administration centre, where it is compared with the information which should be there.

Another application of the system according to the invention is the controlling of heavy goods vehicles, as mentioned above. In this case, not only does the chip card contain all of the static information necessary for controlling the vehicle, as is the case for all vehicles, but also the dynamic information regarding the distance covered in kilometres, the break times and the speed, over a set period of time, for example one day. It should be noted that the dynamic information could also be registered for light vehicles in the near future.

The chip card used in this case can be a contactiess card, in which case it communicates, by means of electromagnetic waves, with the dynamic data recording device. The card can also be a hybrid contact-contactiess card connected (via its contacts) to the recording device by means of a wire connection.

The chip card used for heavy goods vehicles can be associated with the vehicle driver as is the case with the currently used paper control chart currently used. However, it is preferable for the card to be associated with the vehicle insofar as it has sufficient capacity to record the data relating to a plurality of drivers, which was obviously not the case with paper charts.

The communication between the data input device and the chip card must be secure in order to prevent falsified cards from being used by dishonest drivers, the use of fake data input devices with the aim of gathering information located on the cards, or the modification of information with the aim of deceiving control officials.

The messages between the data input device and the card or between the data input device and an administration centre all have the same structure. They include a data field and a signature. The signature results from “hashing” the encrypted data field using the private key of the sender. The data field contains the identifier of the sender and a header includes the identifier of the receiver. The data field can be transmitted openly or can optionally be encrypted using the public key of the receiver. When the receiver has received the message and, if necessary, after decryption using its private key, the signature is decrypted using the public key of the sender and the data field is “hashed”. The result of this hashing must be identical to the result of the signature received after decryption.

The data input devices are not all authorised to gather all of the information located on the card or to get connected to all of the administration centres. Indeed, the control officials are generally law enforcement officials but have different powers depending on whether they belong to the national police force, the local police force, or the Gendarmerie. For example, a national police officer may be in possession of data input device giving access to all of the card information and to all of the administration centres, whereas a local police officer may only have access to the card information relating to the controlling of the vehicle and therefore only has access to the vehicle testing centre. In order to do so, each data input device contains the active public keys for the various centres to which it has access.

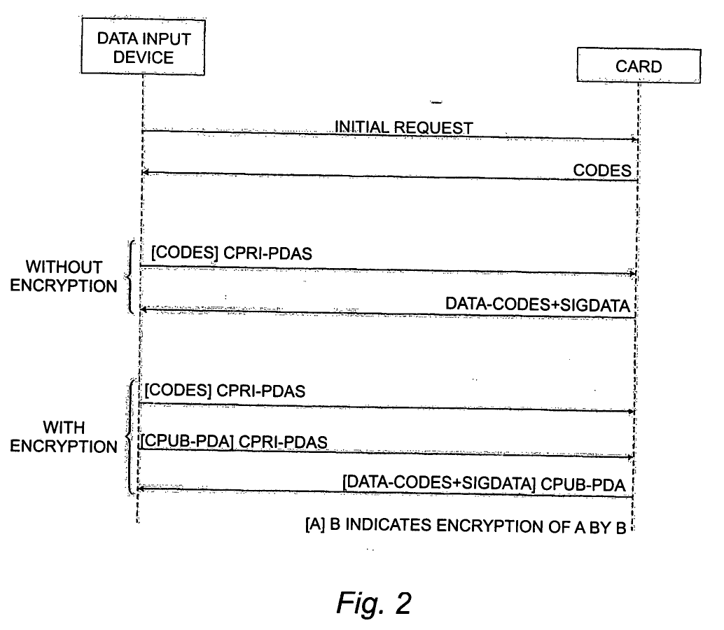

When an officer wishes to inspect a vehicle's card, he activates his data input device and places it in front of the card. Using the message structure defined above, the data input device transmits an INITIAL REQUEST as shown in FIG. 2, and the card gives the identification of the various data which it contains by sending CODES associated with the various information which it contains. This transmission can be effected openly because no confidential data is transmitted. For example, the card shows that it contains data relating to registration certificate, insurance, technical testing, certificate of roadworthiness, list of offences, driving licence.

In response, the data input device selects the code(s) for which it is authorised to request information (it is, in fact, already configured for this operation) and transmits them to the card, encrypting the data transmitted using a private key CPRI-PDAS which is common to all of the data input devices. It should be noted that this transmission can be accompanied by the public key CPUB-PDA of the data input device which the card will then use to encrypt the data of the next messages, such that this data can be decoded by the data input device using its private key. The card has the public key which is common to all of the data input device and uses it to decrypt the received data.

The card responds by transmitting the data associated with each preference code in separate messages. Each message or message part, contains the data signature (as explained above) established upon creation of the card by the administration centre which is responsible for this data and which renders the card data non-modifiable. This signature is created using the centre's private key. It is added to the data with an identifier of the centre which enables the corresponding public key to be retrieved.

In fact, the transmission of the required data from the card can be carried out in two ways depending on whether the data must be encrypted or not. The need for encryption is indicated for each code by a single bit which is 1 if it is necessary, or 0 if it is not.

If the data sent back by the card is not encrypted, each message (or message part) is composed of data associated with the code DATA-CODE and of the signature SIGDATA. If the data sent back by the card is encrypted, each message (or message part) is composed of the same elements as previously, encrypted by the public key specific to the data input device CPUB-PDA.

It should be noted that each code is an identifier which can be used to define the public key of the associated centre (contained in the data input device) allowing the signature of all of the information provided by the card to be checked. The public key/private key pair of the centre does have to be changed periodically, for example every year, and the data input device can thus make use of this identifier in order to determine which is the public key of the centre to be used to check the signature. Thus, the code may end in 03 to indicate that the public key corresponding to 2003 should be used.

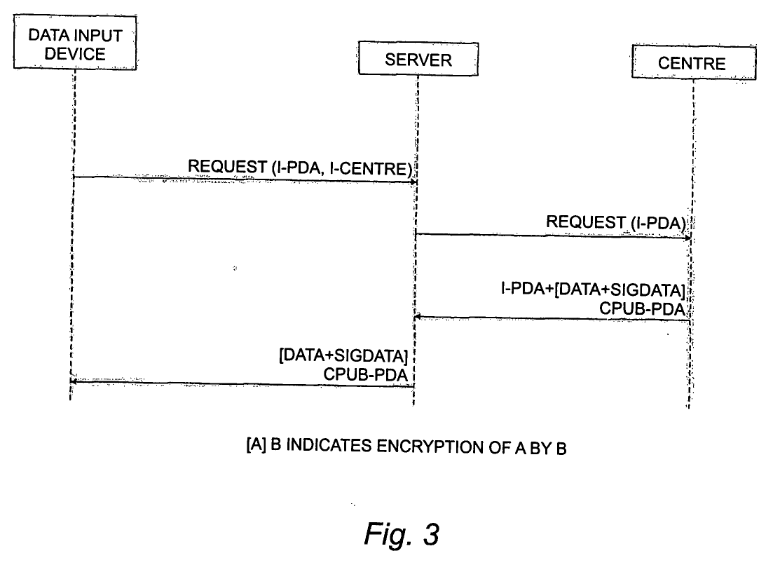

As already mentioned, the data input device may need to connect to a centre to check some information. In this case, it sends the centre messages signed using its private key and possibly encrypted using the public key of the centre. The centre responds with messages signed using its private key and encrypted using the public key of the data input device. As illustrated in FIG. 3, the request messages transmitted by the data input device comprise the identification of the data input device I-PDA and the identification of the centre I-CENTRE. The messages pass through the server 20 which identifies the required centre and transmits the message to this centre. The centre sends back the requested data DATA and the signature of this data SIGDATA encrypted using the public key of the data input device CPUB-PDA, with the messages passing through the server which identifies the data input device using its identifier I-PDA.

When, after inspecting the card data and possibly checking with the centre(s), it is found that the vehicle is in breach of the regulations, the police officer may then issue a ticket. To do so, it is advisable to use the system described in European Patent 1,034,499 and Patent Application PCT/FR02/01103. In this case, the data input device has a keyboard and/or voice recognition means and/or a selective research means allowing the police officer to enter or select the parameters of the ticket by typing on the keyboard, or orally using voice recognition means, or by selecting data stored in the data input device. After entering or selecting this data, the police officer inserts a contact ticket card into the data input device in order to record therein the parameters of the ticket, or places a contactless ticket card in front of the data input device to record said parameters into the card according to the conventional art regarding contactless cards. The ticket card is then clipped onto the windscreen-wiper arm of the vehicle as described in the two patents cited above.

1. A system for controlling information relating to a vehicle in which a chip card, containing the information relating to the criteria which the vehicle must satisfy according to the regulations in force, can be inspected by any authorised person in order to carry out the controlling of static and/or dynamic information relating to said vehicle using a data input device,
wherein said chip card is a contactless chip card placed permanently inside said vehicle and said data input device includes a contactless card reader adapted to remotely read the information recorded in said card and a display screen onto which said information is displayed.

2. The system according to claim 1, wherein the static information contained in said contactless chip card includes the type of vehicle, the registration number, the identification number, the insurance contract number and its validity.

3. The system according to claim 1, wherein said contactless chip card further contains dynamic information relating to the distance covered by said vehicle over a set period of time, for example, a day, as is the case with heavy goods vehicles.

4. The system according to claim 1, further including one or more administration centres to which said data input device can be connected, said centres being authorised to administer the various static and/or dynamic information relating to said vehicle.

5. The system according to claim 4, wherein said data input device has connection means enabling it to connect to each of said centres through a cellular telephone network and a server.

6. The system according to claim 5, wherein the information contained in said contactless chip card is associated with codes identifying it, said codes being provided by said card upon each inspection of said card and said data input device being authorised to request information associated with one or more of said codes.

7. The system according to claim 6, wherein said data input device requests the data associated with one or more of said codes by transmitting the selected codes to said contactless chip card after encryption using a private key (CPRI-PDAS) common to all of the data input devices, said card decrypting the received encrypted data using the common public key associated with said common private key.

8. The system according to claim 7, wherein each code contains one bit, the 0 or 1 value of which determines the need to encrypt the data associated with said code during the transmission of said data by said contactless chip card, the encryption being carried out using the public key (CPUB-PDA) specific to said data input device, the encrypted data being decrypted by said data input device using the private key associated with said public key.

9. The system accord to claim 6, wherein the data messages transmitted between said data input device and said card include a data field and a signature resulting from hashing of said data field and encryption of the result by the private key of the sender, the card or the data input device.

10. The system according to claim 1, wherein said data input device includes a keyboard or a voice recognition means or a selective research means enabling said authorised person to record, in a ticket card, the parameters of a ticket when the information provided by said contactless chip card do not comply with the regulations in force, said ticket card being then clipped onto the windscreen-wiper arm of said vehicle.
